(19) United States
(12) Patent Application Publication
(10) Pub. No.: US 2017/0174819 A1
(43) Pub. Date: Jun. 22, 2017

(54) ACRYLATE-TERMINATED URETHANE POLYBUTADIENES FORMED FROM LOW-MONOMER 1:1 MONOADDUCTS OF REACTIVE OLEFINIC COMPOUNDS AND DIISOCYANATES AND HYDROXY-TERMINATED POLYBUTADIENES

(71) Applicants: Laura RAMON-GIMENEZ, Essen (DE); Niko HABERKORN, Dorsten (DE); Kai-Steffen KRANNIG, Dortmund (DE); Hsin-Ho WU, Hsinchu County (TW); Juergen STEIGER, Taipei City (TW); Tung-Yi SUN, Taipei (TW)

(72) Inventors: Laura RAMON-GIMENEZ, Essen (DE); Niko HABERKORN, Dorsten (DE); Kai-Steffen KRANNIG, Dortmund (DE); Hsin-Ho WU, Hsinchu County (TW); Juergen STEIGER, Taipei City (TW); Tung-Yi SUN, Taipei (TW)

(73) Assignee: Evonik Degussa GmbH, Essen (DE)

(21) Appl. No.: 15/385,328

(22) Filed: Dec. 20, 2016

(30) Foreign Application Priority Data
Dec. 21, 2015 (EP) 15201639

(51) Int. Cl. C08G 18/69; C08G 18/34; C08G 18/30; C08G 18/75; C08G 18/24

(52) U.S. Cl. CPC C08G 18/69; C08G 18/755; C08G 18/242; C08G 18/30; C08G 18/34

(57) ABSTRACT

Acrylate-terminated urethane polybutadienes are obtained by reaction of low-monomer 1:1 monoadducts of reactive olefinic compounds and diisocyanates with hydroxy-terminated polybutadienes.

### BACKGROUND OF THE INVENTION

Field of the Invention

This invention relates to acrylate-terminated urethane polybutadienes formed from low-monomer 1:1 monoadducts of reactive olefinic compounds and diisocyanates and hydroxy-terminated polybutadienes, and to a process for preparation.

Description of the Related Art

The preparation of acrylate-terminated urethane polybutadienes has been described in the patent literature as early as the end of the 1960s. Japan Soda describes, in several patents, for example DE1944015, the preparation of such functionalized polybutadienes. Such products are also mentioned in U.S. Pat. No. 3,855,379, DE2244918A1, JP49117588A, JP49117595A, JP50153088A, JP50153091A, JP50150792A, GB1575584A, DE2702708A1, DE2737174A1, DE2821500A1, JP56060441A, BR8101674A, JP59021544A, CA1253289A1, JP60195150A, JP60151260A, JP61006155A, JP61021120A, JP60195038A, JP61123649. Patent JP2002371101A disclosed the utilization of tin catalysts, and patent EP2910578A1 and U.S. Pat. No. 8,822,600B2 utilized organoaluminium, organozinc and, correspondingly, organobismuth and organozirconium as catalysts. It appears here that such catalysts are advantageous over Sn-containing catalysts because of the small rise in viscosity as a function of time. Even today, there is still a need for novel acrylate-terminated urethane polybutadienes having properties that have not been observed to date.

The versatility of polymers can have a direct influence on the versatility of their physical properties. This is reflected by the advances in molecular synthesis and design over the years. In other words, synthetic polymers have numerous adjustable properties which allow for their use in various technology platforms. These adjustable properties can be optimized as soon as the polymer is large enough and/or it has a sufficiently narrow molar mass distribution.

One of the main restrictions in the current polymerization methods or polymer-analogous reactions is that individual polymer chains only rarely keep the same polymerization levels and molar masses. In other words, polymerization reactions and many polymer-analogous conversion reactions typically generate a distribution of polymer sizes around a mean value. In some cases, this heterogeneity is unwanted. For example, the performance of even relatively small polymers, such as photoresists and polyacrylate detergents (MW ˜5000), rises when the polydispersity index (PDI) falls. It is also generally assumed that the increase in the polymer chain length improves many physical properties, especially the mechanical properties. However, the technical challenges of the synthesis of polymers having low PDI are typically much more significant when the synthesis of larger polymers is attempted.

### SUMMARY OF THE INVENTION

For many applications of acrylate-terminated urethane polybutadienes, it is crucial to have good control over the molecular weight distribution, i.e. a minimum polydispersity. The problem was to find acrylate-terminated urethane polybutadienes in which the polydispersity is as close as possible to the original polydispersity of the hydroxy-terminated polybutadiene.

### DETAILED DESCRIPTION OF THE INVENTION

The problem was solved by the reaction of low-monomer 1:1 monoadducts of reactive olefinic compounds and isocyanates with hydroxy-terminated polybutadienes.

It has been found that, surprisingly, acrylate-terminated urethane polybutadienes formed from low-monomer 1:1 monoadducts of reactive olefinic compounds and isocyanates and hydroxy-terminated polybutadienes have an increase in polydispersity of less than 30%, based on the hydroxy-terminated polybutadienes originally used to form the low-monomer 1:1 monoadducts.

The invention provides acrylate-terminated urethane polybutadienes obtained by reaction of
A) at least one low-monomer 1:1 monoadduct having a free diisocyanate content of below 2.0% by weight formed from
   a1) at least one aliphatic, cycloaliphatic and/or araliphatic diisocyanate
   and
   a2) at least one reactive olefinic compound having at least one methacrylate group and/or acrylate group and/or vinyl ether group and having exactly one OH group
   and
B) at least one hydroxy-terminated polybutadiene and/or at least one partly or fully hydrogenated hydroxy-terminated polybutadiene.

The ratio of the NCO groups of component A) to the OH groups of component B) is 1.2:1 to 1:40, preferably 1.2:1 to 1:10 and more preferably 1.1:1 to 1:3.

The acrylate-terminated urethane polybutadienes according to the invention preferably have an NCO content of <0.5% by weight, preferably less than 0.2% by weight, more preferably less than 0.1% by weight.

The reaction of components A) and B) can be conducted in the presence of at least one customary polymerization inhibitor C) which is added before or during the reaction. It is also possible to add at least one polymerization inhibitor C) subsequently to stabilize the acrylate-terminator urethane polybutadiene. It is of course possible to use mixtures of inhibitors as well.

The invention thus also provides acrylate-terminated urethane polybutadienes obtained by reaction of
A) at least one low-monomer 1:1 monoadduct having a free diisocyanate content of below 2.0% by weight formed from
   a1) at least one aliphatic, cycloaliphatic and/or araliphatic diisocyanate
   and
   a2) at least one reactive olefinic compound having at least one methacrylate group and/or acrylate group and/or vinyl ether group and having exactly one OH group
   and
B) at least one hydroxy-terminated polybutadiene and/or at least one partly or fully hydrogenated hydroxy-terminated polybutadiene;
C) optionally comprising at least one polymerization inhibitor C).

The classification of a standard of broad and narrow distribution is based on the polydispersity index, also called polydispersity, PD=Mw/Mn.

The inventive reaction of low-monomer 1:1 monoadducts and hydroxy-terminated polybutadienes leads to products exhibiting an increase in polydispersity of not more than 30%, preferably not more than 20%, more preferably not more than 10%, based on the hydroxy-terminated polybutadienes originally used to form the low-monomer 1:1 monoadducts.

The low-monomer 1:1 monoadducts A) having a free diisocyanate content of less than 2.0% by weight can be prepared, for example, as described in EP 2 367 864 from the starting compounds:
a1) at least one aliphatic, cycloaliphatic and/or araliphatic diisocyanate in an amount of 1-20 mol,
and
a2) 1 mol of at least one reactive olefinic compound having at least one methacrylate group and/or acrylate group and/or vinyl ether group and having exactly one OH group,
   obtained by reaction with a temperature range of 40-120° C., and by then separating the unconverted diisocyanate from the reaction product by a short-path distillation at 80-220° C./0.01-10 mbar,
by effecting the short-path distillation in the presence of
a3) at least one inhibitor having at least one functional group reactive toward NCO groups.

The low-monomer 1:1 monoadducts A) of diisocyanates a1) and reactive olefinic compounds a2) having a free isocyanate content of less than 2% by weight are obtained in principle by reaction of 1-20 mol, preferably 1-5 mol, more preferably 1.5-4 mol, of diisocyanate a1) with 1 mol of a reactive olefinic compound a2) within a temperature range of 40-120° C., preferably 40-80° C., by conducting the reaction up to complete conversion of the reactive olefinic compound a2) and then separating the unconverted diisocyanate from the reaction product by a short-path distillation at 80-220° C. and a pressure of 0.01-10 mbar. The specific inhibitors a3) are added before and/or during and/or after the reaction.

The excess diisocyanate is removed by distillation in short-path evaporators, preferably using thin-film evaporators, or falling-film evaporators. The distillation is conducted at 80-220° C., preferably at 100-180° C., and a pressure of 0.01-10 mbar, preferably 0.05 to 5 mbar. The short-path evaporator may, for example, be a glass, enamel or else metal apparatus. The low-monomer 1:1 monoadducts thus obtained have a content of monomeric isocyanates of less than 2% by weight, preferably less than 0.5% by weight.

If the reaction is conducted in a solvent, the solvent is removed by distillation prior to the removal of the residual monomer content.

Suitable isocyanates a1) are araliphatic, cycloaliphatic and araliphatic, i.e. aryl-substituted aliphatic, diisocyanates, as described, for example, in Houben-Weyl, Methoden der organischen Chemie [Methods of Organic Chemistry], volume 14/2, pages 61-70 and in the article by W. Siefken, Justus Liebigs Annalen der Chemie 562, 75-136, such as ethylene 1,2-diisocyanate, tetramethylene 1,4-diisocyanate, hexamethylene 1,6-diisocyanate (HDI), 2,2,4-trimethylhexamethylene 1,6-diisocyanate (TMDI), 2,4,4-trimethylhexamethylene 1,6-diisocyanate (TMDI), 1,9-diisocyanato-5-methylnonane, 1,8-diisoeyanato-2,4-dimethyloctane, dodecane 1,12-diisocyanate, ω,ω′-diisocyanatodipropyl ether, cyclobutene 1,3-diisocyanate, cyclohexane 1,3-diisocyanate, cyclohexane 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethylcyclohexane, decahydro-8-methyl-(1,4-methanonaphthalen-2,5-ylenedimethylene diisocyanate), decahydro-8-methyl-(1,4-methanonaphthalen-3,5-ylenedimethylene diisocyanate), hexahydro-4,7-methanoindan-1,5-ylenedimethylene diisocyanate, hexahydro-4,7-methanoindan-2,5-ylenedimethylene diisocyanate, hexahydro-4,7-methanoindan-1,6-ylenedimethylene diisocyanate, hexahydro-4,7-methanoindan-2,5-ylenedimethylene diisocyanate, hexahydro-4,7-methanoindan-1,5-ylene diisocyanate, hexahydro-4,7-methanoindan-2,5-ylene diisocyanate, hexahydro-4,7-methanoindan-1,6-ylene diisocyanate, hexahydro-4,7-methanoindan-2,6-ylene diisocyanate, hexahydrotolylene 2,4-diisocyanate, hexahydrotolylene 2,6-diisocyanate, methylene dicyclohexyl 4,4′-diisocyanate (4,4′-H₁₂MDI), methylene dicyclohexyl 2,2′-diisocyanate (2,2′-H₁₂MDI), methylene dicyclohexyl 2,4-diisocyanate (2,4-H₁₂MDI) or else mixtures of these isomers, 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, m-xylylene diisocyanate (MXDI), m-tetramethylxylene diisocyanate (m-TMXDI). It is also possible to use any desired mixtures of these compounds.

Other suitable isocyanates are described in the stated article in Liebigs Annalen on page 122 f. Also suitable are 2,5-bis(isocyanatomethyl)bicyclo[2.2.1]heptane (NBDI) and/or 2,6-bis(isocyanatomethyl)bicyclo[2.2.1]heptane (NBDI), as the pure substance or as a mixed component. It is of course possible to use mixtures as well.

These diisocyanates are nowadays prepared generally either by the phosgene route or by the urea process. The products of both methods are equally suitable for use in the process of the invention.

Particular preference is given to using aliphatic and cycloaliphatic diisocyanates.

Very particular preference is given to using diisocyanates selected from IPDI, TMDI, HDI, H₁₂MDI and the H₁₂MDI isomer mixtures. It is of course possible to use mixtures as well.

Suitable reactive olefinic compounds a2) are all compounds which bear both at least one methacrylate group and/or acrylate group and/or vinyl ether group and exactly one hydroxyl group. Further constituents may be aliphatic, cycloaliphatic, aromatic or heterocyclic alkyl groups. Also suitable are oligomers or polymers.

Preference is given to using hydroxyethyl acrylate, hydroxypropyl acrylate, hydroxybutyl acrylate and hydroxyethyl methacrylate, hydroxypropyl methacrylate, hydroxybutyl methacrylate, glycerol diacrylate, pentaerythritol triacrylate, trimethylolpropane diacrylate, glycerol dimethacrylate, pentaerythritol trimethacrylate and trimethylolpropane dimethacrylate, and also hydroxyethyl vinyl ether, hydroxypropyl vinyl ether, hydroxybutyl vinyl ether, hydroxypentyl vinyl ether and/or hydroxyhexyl vinyl ether. It is of course possible to use mixtures as well. Particular preference is given to using hydroxyethyl acrylate.

Incorporatable inhibitors a3) have nonaromatic NCO-reactive functional groups, preferably hydroxyl, thiol or amine groups, which can enter into covalent bonds with isocyanates. Reactive functional groups of this kind that are bonded to aromatic groups do react with NCO groups, but are generally detached again under the distillation conditions and are therefore unsuitable for incorporation. Useful compounds are thus all of those that are used commercially as polymerization inhibitors (see chapter which follows), but additionally also have nonaromatic groups reactive toward isocyanates, preferably hydroxyl, thiol or amine groups. Preferably, the reactive functional groups are bonded to an aliphatic or cycloaliphatic hydrocarbyl radical. Such compounds are described, for example, in U.S. Pat. No. 4,260,832 and GB 226 47 08. Useful examples include 3,5-di-tert-butyl-4-hydroxybenzyl alcohol, 3-(3,5-di-tert-butyl-4-hydroxyphenyl)propanol, 4-(3,5-di-tert-butyl-4-hydroxyphenyl)butanol, 5-(3,5-di-tert-butyl-4-hydroxyphenyl)pentanol, 6-(3,5-di-tert-butyl-4-hydroxyphenyl)hexanol, 3-tert-butyl-5-methyl-4-hydroxybenzyl alcohol, 3-(3,5-di-tert-butyl-4-hydroxyphenyl)propanol, 4-(3-tert-butyl-5-methyl-4-hydroxyphenyl)butanol, 5-(3-tert-butyl-5-methyl-4-hydroxyphenyl)pentanol, 6-(3-tert-butyl-5-methyl-4-hydroxyphenyl)hexanol, 3,5-di-tert-butyl-4-hydroxybenzyl alcohol, 3-(3,5-di-tert-butyl-4-hydroxyphenyl)propanol, 4-(3,5-dimethyl-4-hydroxyphenyl)butanol, 5-(3,5-di-dimethyl-4-hydroxyphenyl)pentanol, 6-(3,5-dimethyl-4-hydroxyphenyl)hexanol, alone or in mixtures. Preference is given to using 3,5-di-tert-butyl-4-hydroxybenzyl alcohol.

The presence of further commercial polymerization inhibitors (antioxidants) is advantageous.

Hydroxy-Terminated Polybutadiene B)

In the context of the present invention, hydroxy-terminated polybutadiene is B) are used for the reaction with the above-described low-monomer adducts. These may be used in unhydrogenated form or else in partly or fully hydrogenated form.

In a particularly preferred embodiment of the present invention, the hydroxy-terminated polybutadiene comprises the 1,3-butadiene-derived monomer units

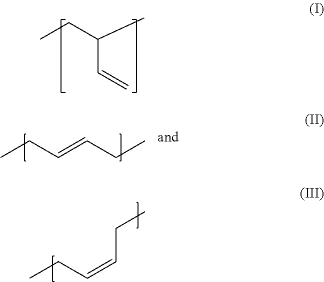

wherein the proportion of (I) in the entirety of the 1,3-butadiene-derived monomer units present in the polybutadiene is 10 to 60 mole percent, and wherein the sum total of the proportions of (II) and (III) in the entirety of the 1,3-butadiene-derived monomer units present in the polybutadiene is 40 to 90 mole percent.

The abovementioned hydroxyl-terminated polybutadiene is a polybutadiene having hydroxyl groups produced by free-radical polymerization of 1,3-butadiene, in each case comprising the 1,3-butadiene-derived monomer units (I), (II) and (III) present in the polybutadiene, where a square bracket in the formula representation chosen in this application for the 1,3-butadiene-derived monomer units (I), (II) and (III) present in the polybutadiene shows that the bond marked with the respective square bracket does not end with a methyl group, for instance; instead, the relevant monomer unit is bonded via this bond to another monomer unit or a hydroxyl group. These monomer units (I), (II) and (III) may be arranged in the polymer in any desired sequence. A random arrangement is preferred.

In a preferred embodiment, the proportion of (I), (II) and (III) in the entirety of the 1,3-butadiene-derived monomer units present in the polybutadiene is in each case independently at least 10 mol %.

Especially preferably, the proportion of (I) in the entirety of the 1,3-butadiene-derived monomer units present in the polybutadiene is 15 to 30 mol %, the proportion of (II) in the entirety of the 1,3-butadiene-derived monomer units present in the polybutadiene is 50 to 70 mol % and the proportion of (III) in the entirety of the 1,3-butadiene-derived monomer units present in the polybutadiene is 15 to 30 mol %. The mean molecular weight, determined by gel permeation chromatography, of the hydroxy-terminated polybutadienes is typically between 500 and 10000 g/mol, preferably between 1000 and 5000 g/mol, more preferably between 1500 and 4000 g/mol.

In a preferred embodiment, in addition to the 1,3-butadiene-derived monomer units (I), (II) and (III) present in the polybutadiene, other monomer units may also be present, especially those that are not derived from 1,3-butadiene. In a preferred embodiment, however, the entirety of the 1,3-butadiene-derived monomer units (I), (II) and (III) present in the polybutadiene represents a proportion of the entirety of the monomer units incorporated in the polymer and comprising the 1,3-butadiene-derived units and other units of at least 80, preferably 90, more preferably 95 and most preferably 100 mole percent.

The hydroxy-terminated polybutadienes B) used in accordance with the invention are prepared by means of free-radical polymerization, for example by polymerization of 1,3-butadiene in the presence of hydrogen peroxide, water and an organic solvent. Suitable processes are described, for example, EP 2 492 292.

The polybutadienes B) usable with preference in the context of the present invention are commercially available, for example in the form of POLYVEST® HT from Evonik Resource Efficiency GmbH.

The invention also provides a process for preparing acrylate-terminated urethane polybutadienes by reaction of
A) at least one low-monomer 1:1 monoadduct having a free diisocyanate content of below 2.0% by weight formed from
   a1) at least one aliphatic, cycloaliphatic and/or araliphatic diisocyanate
   and
   a2) at least one reactive olefinic compound having at least one methacrylate group and/or acrylate group and/or vinyl ether group and having exactly one OH group
   and
B) at least one hydroxy-terminated polybutadiene and/or at least one partly or fully hydrogenated hydroxy-terminated polybutadiene;
C) optionally in the presence of at least one polymerization inhibitor C).

The reaction of polyisocyanates with reactive hydroxy-terminated polymers includes the reaction of the free NCO groups with hydroxyl groups and has already been described frequently (EP 0 669 353, EP 0 669 354, DE 30 30 572 EP 0 639 598 or EP 0 803 524). This reaction may take place either with or else without solvent. It is generally conducted within a temperature range between 40-120° C., preferably 40 and 80° C., and can advantageously be catalysed by common catalysts known in urethane chemistry, for example organometallic compounds, for example dibutyltin dilaurate (DBTL), dibutyltin dineodecanoate, zinc octoate or bismuth neodecanoate, or else by tertiary amines, such as triethylamine or diazabicyclooctane, etc. Suitable reaction assemblies include all customary apparatus, tanks, static mixers, extruders, etc., preferably assemblies which possess a mixing or stirring function. The ratio of the NCO groups of component A) to the OH groups of component B) is 1.2:1 to 1:40, preferably 1.2:1 to 1:10 and more preferably 1.1:1 to 1:3.

The preparation can be effected by initially charging all the reactants together, or else by stepwise or continuous addition of one or more reactants. If solvents have been used, these can be removed by evaporation under reduced pressure.

The acrylate-terminated urethane polybutadienes formed from low-monomer 1:1 monoadducts A) and hydroxy-terminated polybutadienes B) are obtained by reaction with a temperature range of 40-120° C., preferably 40-80° C., the reaction being conducted up to complete conversion of the NCO groups of the monoadduct A).

It is optionally possible to add any kind of standard polymerization inhibitor C) during the reaction, and subsequently for stabilization of the product. It is of course possible to use mixtures of inhibitors as well.

Suitable inhibitors are, for example, phenol-containing, quinone-containing, P-containing, S-containing or N—O-containing inhibitors. Examples of these are catechol, 4-methoxyphenol, 4-tert-butyloxyphenol, 4-benzyloxyphenol, α-naphthol, β-naphthol, phenothiazine, 10,10-dimethyl-9,10-dihydroacridine, bis[2-hydroxy-5-methyl-3-cyclohexylphenyl]methane, bis[2-hydroxy-5-methyl-3-tert-butylphenyl]methane, hydroquinone, pyrogallol, 3,4-dihydroxy-1-tert-butylbenzene, 4-methoxy-2(or 3)-tert-butylphenol (BHA), BHA also in combination with bis[2-carboxyethyl] sulphide (TDPA), 4-methyl-2,6-di-tert-butylphenol (BHT), bis[4-hydroxy-2-methyl-5-tert-butylphenyl] sulphide, 4-butylmercaptomethyl-2,6-di-tert-butylphenol, dioctadecyl 4-hydroxy-3,5-di-tert-butylphenylmethanesulphonate, 2,5-dihydroxy-1-tert-butylbenzene, 2,5-dihydroxy-1,4-di-tert-butylbenzene, 3,4-dihydroxy-1-tert-butylbenzene and 2,3-dimethyl-1,4-bis[3,4-dihydroxyphenyl]butane. Also useful are all commercial organic or inorganic N—O-containing compounds.

The phenolic antioxidants can also be combined with phosphorous esters of formula. A below, where X is oxygen or sulphur, and where R¹, R² and R³ represent identical or different alkyl, alkylen-1-yl, aryl or aralkyl radicals each having 1-20 carbon atoms.

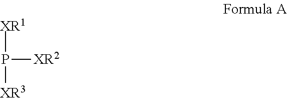

The phenolic antioxidants can also be combined with thioethers or amines, for example 2-anilinonaphthalene (PBN), 1-anilinonaphthalene (PAN) or 1,4-dianilinobenzene. It is of course also possible to use substances that are standard on the market which, on the basis of their chemical structure, combine two or more polymerization-inhibiting principles in one, for example 2,2′-thiobis(4-tert-octylphenol). Preference is given to using phenothiazine, 2,6-di-tert-butyl-4-(4,6-bis(octylthio)-1,3,5-triazin-2-ylaminophenol and 4-methyl-2,6-di-tert-butylphenol and 4,4′-methylenebis-2,6-di-tert-butylphenol. The amount of this component C), if present, is between 0.001% and 3% by weight, based on the sum total of components A) and B).

The acrylate-terminated urethane polybutadienes according to the invention preferably have an NCO content of <0.5% by weight, preferably less than 0.2% by weight, more preferably less than 0.1% by weight.

The inventive reaction of low-monomer 1:1 monoadducts and hydroxy-terminated polybutadienes leads to products exhibiting an increase in polydispersity of not more than 30%, preferably not more than 20%, more preferably not more than 10%, based on the hydroxy-terminated polybutadienes originally used to form the low-monomer 1:1 monoadducts.

The products which have been described in this patent can be used in various applications such as adhesives, paints, sealants, plastics and composites. The small increase in polydispersity results in a more specific structure of the modified polybutadienes with defined and controllable properties.

Having generally described this invention, a further understanding can be obtained by reference to certain specific examples which are provided herein for purposes of illustration only, and are not intended to be limiting.

### EXAMPLES

| Starting materials | Product description, manufacturer |
|---|---|
| VESTANAT ® | Isophorone diisocyanate, Evonik Industries AG, |
| IPDI | Coatings & Additives |
| HEA | Hydroxyethyl acrylate, Aldrich |
| DBTL | Dibutyltin dilaurate, urethanization catalyst, Aldrich |
| POLYVEST ® HT | Hydroxy-terminated polybutadiene, polydispersity |
| | PD = 2.10, Evonik Resource Efficiency GmbH |
| | OH number = 46-50 mg KOH/g |
| BHT | 4-methyl-2,6-di-tert-butylphenol |
| VESTANAT ® EP | Low-monomer 1:1 monoadduct of IPDI and HEA, |
| DC 1241 | monomer content of IPDI 0.05%, Evonik |
| | Resource Efficiency GmbH |

### Example 1

Preparation of a Conventional Acrylate-Terminated Urethane Polybutadiene, Non-Inventive

A)

To a vigorously stirred mixture of 222 g (1 mol) of IPDI and 0.05 g of DBTL with 2.2 g (0.5% by weight) of BHT was added dropwise 116 g (1 mol) of hydroxyethyl acrylate (HEA), in the course of which dry air was passed over the solution. After the addition had ended, stirring was continued at 70° C. until conversion of the hydroxyethyl acrylate alcohol component was complete (generally 2-4 hours). During this reaction time as well, dry air was passed over. The product had an NCO number of 11.8%.

B)

Subsequently, 77.11 g of POLYVEST HT and 0.05% by weight of the catalyst (DBTL) were initially charged under nitrogen in a three-neck flask fitted with a dropping funnel and thermometer and heated to 60° C. Once this temperature had been attained, 22.85 g of the product of IPDI and HEA described in A) were added via the dropping funnel with stirring and the reaction mixture was stirred for three hours. The end of the reaction was ascertained by determining the residual isocyanate content (NCO <0.1% by weight) via titration.

GPC (polystyrene standard): Mₙ=3206 g/mol; =10 180 g/mol;

PD=3.17

Increase in polydispersity=53%

### Example 2

Preparation of an Acrylate-Terminated Urethane Polybutadiene with Use of a Low-Monomer 1:1 Monoadduct, Inventive (POLYVEST EP-AT)

77.11 g of POLYVEST HT and 0.05% by weight of the catalyst (DBTL) were initially charged under nitrogen in a three-neck flask fitted with a dropping funnel and thermometer and heated to 60° C. Once this temperature had been attained, 22.85 g of VESTANAT EP DC 1241 (NCO number of 11.6%, a proportion by weight of 0.05% IPDI) were added via the dropping funnel with stirring and the reaction mixture was stirred for three hours. The end of the reaction was ascertained by determining the residual isocyanate content (NCO <0.1% by weight) via titration.

GPC (polystyrene standard): Mₙ=3716 g/mol; M_{w}=7165 g/mol.

PD=2.13

Increase in polydispersity=3%

These results showed that the use of low-monomer 1:1 monoadducts for the preparation of acrylate-terminated urethane polybutadienes according to Example 2 led to an increase in polydispersity of <30%, while the conventional use of diisocyanates and hydroxyalkyl acrylates according to Example 1 led to an increase in polydispersity of the end product of >50%.

Methods

Gel Permeation Chromatography (GPC)

Measurements were carried out at 40° C. in tetrahydrofuran (THF) at a concentration of 1 g/l and a flow rate of 0.3 ml/min. Chromatographic separation was achieved using a PSS SDV Micro 5μ/4.6×30 mm precolumn and a PSS SDV Micro linear S 5μ/4.6×250 mm (2×) separation column. Detection was by means of an RI detector. Calibration was conducted by means of a polybutadiene standard (PSS-Kit polybutadiene-1,4, Mp 831-106000, Part No.: PSS-bdfkit, Mu: 1830/4330/9300/18000/33500).

The molecular weights Mn and Mw were ascertained by a computer-assisted evaluation of the chromatograms. The polydispersity index (PDI) was calculated from the quotient of Mn and Mw.

NCO Number

The measurements were conducted with a titrator (Titrando 905 from Metrohm) and an n-butylamine solution (1 N).

Monomer Content (% IPDI)

The remaining % of IPDI was determined by GC (gas chromatography). For chromatographic separation, a fused silica capillary column was used. Detection was by means of an FID detector. The calibration was conducted by means of IPDI and n-tetradecane as internal standard.

European patent application 15201639 filed Dec. 21, 2016, is incorporated herein by reference.

Numerous modifications and variation on the present invention are possible in light of the above teachings. It is therefore to be understood that within the scope of the appended claims, the invention may be practiced otherwise that as specifically described herein

1. An acrylate-terminated urethane polybutadiene obtained by reaction of
A) at least one low-monomer 1:1 monoadduct which has a free diisocyanate content of below 2.0% by weight relative to the total weight of the low-monomer 1:1 monoadduct
obtained by reaction of
a1) at least one compound selected from the group consisting of an aliphatic diisocyanate, a cycloaliphatic diisocyanate, and an araliphatic diisocyanate
and
a2) at least one reactive olefinic compound comprising at least one functionality selected from the group consisting of a methacrylate group, an acrylate group, and a vinyl ether group and further comprising one OH group
and
B) at least one hydroxy-terminated polybutadiene.

2. The acrylate-terminated urethane polybutadiene according to claim 1 obtained by reaction of
A) at least one low-monomer 1:1 monoadduct which has a free diisocyanate content of below 2.0% by weight relative to the total weight of the low-monomer 1:1 monoadduct
obtained by reaction of
a1) at least one compound selected from the group consisting of an aliphatic diisocyanate, a cycloaliphatic diisocyanate, and an araliphatic diisocyanate
and
a2) at least one reactive olefinic compound comprising at least one functionality selected from the group consisting of a methacrylate group, an acrylate group, and a vinyl ether group and further comprising one OH group
and
B) at least one hydroxy-terminated polybutadiene; in the presence of
C) at least one polymerization inhibitor C).

3. The acrylate-terminated urethane polybutadiene according to claim 1, wherein the ratio of NCO groups of the low-monomer 1:1 monoadduct component A) to OH groups of the hydroxy-terminated polybutadiene component B) is 1.2:1 to 1:40.

4. The acrylate-terminated urethane polybutadiene according to claim 1, which has an NCO content of <0.5% by weight relative to the total weight of the acrylate-terminated urethane polybutadiene.

5. The acrylate-terminated urethane polybutadiene according to claim 1, having an increase in polydispersity of not more than 30%, relative to a polydispersity of the hydroxy-terminated polybutadiene.

6. The acrylate-terminated urethane polybutadiene according to claim 1, wherein the at least one compound selected from the group consisting of an aliphatic diisocyanate, a cycloaliphatic diisocyanate, and an araliphatic diisocyanate component a1) is at least one diisocyanate selected from the group consisting of isophorone diisocyanate, 2,2,4-trimethylhexamethylene 1,6-diisocyanate, 2,4,4-trimethylhexamethylene 1,6-diisocyanate, hexamethylene 1,6-diisocyanate, methylene dicyclohexyl 4,4′-diisocyanate, methylene dicyclohexyl 2,2′-diisocyanate, methylene dicyclohexyl 2,4-diisocyanate and isomer mixtures.

7. The acrylate-terminated urethane polybutadiene according to claim 1, wherein the reactive olefinic compound component a2), comprises a methacrylate group, or an acrylate group, or a vinyl ether group and further comprises one hydroxyl group.

8. The acrylate terminated urethane polybutadiene according to claim 1, wherein the reactive olefinic compound component a2), is at least one compound selected from the group consisting of hydroxyethyl acrylate, hydroxypropyl acrylate, hydroxybutyl acrylate, hydroxyethyl methacrylate, hydroxypropyl methacrylate, hydroxybutyl methacrylate, glycerol diacrylate, pentaerythritol triacrylate, trimethylolpropane diacrylate, glycerol dimethacrylate, pentaerythritol trimethacrylate, trimethylolpropane dimethacrylate, hydroxyethyl vinyl ether, hydroxypropyl vinyl ether, hydroxybutyl vinyl ether, hydroxypentyl vinyl ether, and hydroxyhexyl vinyl ether.

9. The acrylate-terminated urethane polybutadiene according to claim 1, wherein the mean molecular weight, as determined by gel permeation chromatography, of the hydroxy-terminated polybutadiene component B) is between 500 and 10000 g/mol.

10. The acrylate-terminated urethane polybutadiene according to claim 1, wherein the hydroxy-terminated polybutadiene component B) comprises 1,3-butadiene-derived monomer units: 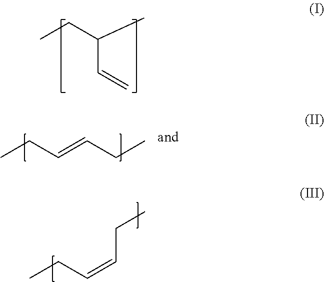
wherein a proportion of (I) relative to the total 1,3-butadiene-derived monomer units present in the hydroxy-terminated polybutadiene is 10 to 60 mole percent, and
wherein the sum of a proportion of (II) and a proportion of (III) relative to the total 1,3-butadiene-derived monomer units present in the hydroxy-terminated polybutadiene is 40 to 90 mole percent.

11. The acrylate-terminated urethane polybutadiene according to claim 10, wherein the hydroxy-terminated polybutadiene component B) has a proportion of (I) relative to the total 1,3-butadiene-derived monomer units present in the hydroxy-terminated polybutadiene of 15 to 30 mol %,
has a proportion of (II) relative to the total 1,3-butadiene-derived monomer units present in the hydroxy-terminated polybutadiene of 50 to 70 mol %, and
has a proportion of (III) relative to the total 1,3-butadiene-derived monomer units present in the hydroxy-terminated polybutadiene of 15 to 30 mol %.

12. A process for preparing the acrylate-terminated urethane polybutadiene according claim 1, the process comprising:
reacting
A) at least one low-monomer 1:1 monoadduct which has a free diisocyanate content of below 2.0% by weight relative to the total weight of the low-monomer 1:1 monoadduct
obtained by reaction of
a1) at least one compound selected from the group consisting of an aliphatic diisocyanate, a cycloaliphatic diisocyanate, and an araliphatic diisocyanate
and
a2) at least one reactive olefinic compound comprising at least one functionality selected from the group consisting of a methacrylate group, an acrylate group, and a vinyl ether group and further comprising one OH group
and
B) at least one hydroxy-terminated polybutadiene; optionally in the presence of
C) at least one polymerization inhibitor C).

13. The process according to claim 12, wherein the reacting is performed within a temperature range of 40-120° C.

14. The acrylate-terminated urethane polybutadiene according to claim 1, wherein the hydroxy-terminated polybutadiene component B) is partly or frilly hydrogenated.

15. The acrylate-terminated urethane polybutadiene according to claim 2, wherein the hydroxy-terminated polybutadiene component B) is partly or fully hydrogenated.

16. The process according to claim 12, wherein the reacting is performed in the presence of at least one polymerization inhibitor C).

17. The process according to claim 12, wherein the hydroxy-terminated polybutadiene component B) is partly or fully hydrogenated.
